(19) United States
(12) Patent Application Publication
(10) Pub. No.: US 2007/0133522 A1
(43) Pub. Date: Jun. 14, 2007

(54) Method and System for Defining, Capturing, and Reporting Performance Data

(76) Inventor: Alex Morgan, Santa Cruz, CA (US)

Correspondence Address: CENTRAL COAST PATENT AGENCY, INC, 3 HANGAR WAY SUITE D, WATSONVILLE, CA, 95076, US

(21) Appl. No.: 11/566,349

(22) Filed: Dec. 4, 2006

Related U.S. Application Data
(60) Provisional application No. 60/749,923, filed on Dec. 12, 2005.

(51) Int. Cl. H04L 12/66

(52) U.S. Cl. 370/352

(57) ABSTRACT

A network-based data management service includes a first network entry point for client-to-business interface and servicing, a second network entry point for client-to-client interface and social interactivity, a data repository for storing secure and public data, an application server running at least one application for result calculation, performance ranking, and report generation, and a template containing data about reporting subjects, rules for reporting, and performance level guidelines.

### CROSS-REFERENCE TO RELATED APPLICATIONS

The present invention claims priority to a U.S. provisional patent application Ser. No. 60/749,923, filed on Dec. 12, 2005.

### BACKGROUND OF THE INVENTION

1. Field of the Invention

The present invention is in the field of business software applications for analyzing and reporting performance data and pertains particularly to a Web and template-based system for enabling definition, capture, and reporting of performance parameters associated with projects, assessments, or business ventures. 2. Discussion of the State of the Art

In the workplace there are many assessment tools, software programs and the like available on the market as off the shelf solutions for individuals or organizations to use to assess, optimize and track business processes or other areas of interest in order to streamline costs, and improve overall viability of the business as a whole or of a select portion of that business.

Some off-the-shelf programs and tools include support from various word processing and database applications used to organize and enter data that will be used in the analysis processes and eventual reporting of results. Many of these programs are centered on so-called “best practices” and are tailored for mostly standard business models like banking models, sales models, supply chain models, investment-risk assessment models and so on. Typically these programs are limited in customization options to the known practices that are considered best practices in that particular industry the application or tool set will apply to. Such “business applications” generally prescribe specific processes as well as types of data captured and reported. The data is typically “hard data” based on business transactions, and as such provides only a portion of the information that businesses require to make forward-looking business decisions.

Because of these factors, many of these products provide limited value since they do not support customization to the extent of quickly incorporating newly discovered best practices in a particular industry. One goal of the present invention is to combine hard and soft data, even data that may be speculative or opinionated into the evaluation process. It has occurred to the inventors that business optimization through performance reporting can be achieved over a shared network in a secure manner and that the actual experiences of business professionals may be voluntarily shared, including new best practices, to improve the overall quality of the industry. This method enables an open forum approach so that sharing of best practices can occur across industries, accelerating their widespread adoption.

Therefore, what is clearly needed is a system and methods for enabling business professionals to quickly develop, apply and improve their own customized solutions for defining, capturing, and reporting performance data and to have those solutions working on their behalf in a secure third party-brokered service environment.

### SUMMARY OF THE INVENTION

A network-based data management service is provided. The service includes a first network entry point for client-to-business interface and servicing, a second network entry point for client-to-client interface and social interactivity, a data repository for storing secure and public data, an application server running at least one application for result calculation, performance ranking, and report generation, and a template containing data about reporting subjects, rules for reporting, and performance level guidelines.

In one embodiment, the network is a data packet network. In a variation of this embodiment, the data packet network is the Internet network. In this embodiment, the first network entry point is a secure Web server connected to the application server. In another embodiment, the first network entry point is an interactive voice response unit connected to the application server. In one embodiment, the second network entry point is a Web server.

In one embodiment, the public data includes templates created by clients, the templates of the form of a table containing suggestive rules for reporting, performance level guidelines, and suggested entity types.

In one embodiment, the application executes upon client directive and aggregates data for one or more periods for one or more entities and performs calculations and scoring according to constraints in the template identified. In another embodiment the application generates one or more reports of a tabular or of a graphical form automatically repeating execution for each subsequent same period of activity.

In one embodiment, the tabular and graphical reports are exportable to a spreadsheet document, a slide presentation document, or a text document. In another embodiment, reports are distributed via email. In another embodiment, the service further includes one or more network server adaptors for connecting to third party data resources on the network and acquiring data from those resources for use in analysis.

In one embodiment, client-to client interface and social interactivity is accomplished through one or a combination of chat, instant messaging, white boarding, electronic posting board, forums, and file sharing any of which may be configured or not to a client interface by the client.

According to another aspect of the present invention, in a network-based data management service, a performance-scoring module is provided. The module includes a class object defined as category, a class object defined as category measure, a class object defined as measure performance anchor, and two or more performance level objects of descending or ascending hierarchy none equal in value to the other. In one embodiment, the module is associated with a template and the objects are defined with attributes specified by the client.

According to another aspect, the system further includes a scoring module accessible to the application, the application using the measure performance values, as defined through a performance anchor model, during the calculation process as variables for performance ranking.

In still another aspect of the present invention, in a network-based data management service, a method for evaluating one or more associate entities of a service client is provided. The method includes the acts (a) identifying and selecting the one or more associate entities for evaluation, (b) identifying and selecting one or more measurable categories for the one or more associate entities selected, (c) identifying and selecting one or more category measures for the selected categories, (d) Identifying and selecting two or more performance anchors that may be associated to the one or more selected category measures, and (e) initiating the evaluation process.

In one aspect, in act (a) the associate entities are one of resellers, manufacturers, or retail locations of business. In this aspect, in act (b), the measurable categories include those supported by hard numerical data and/or soft data like text description and supporting documents. In one aspect, in act (c), the category measures are attributes of the categories. In one aspect, in act (d), at least one of the performance anchors is assigned a value consistent with the snapshot record value of an existing snapshot record. In preferred aspects, in act (d), the calculation of category values and snapshot record values is based on available data and a performance level definition. In one aspect, in act (d), an existing snapshot record value is nested into a separate snapshot record.

### BRIEF DESCRIPTION OF THE DRAWING FIGURES

FIG. 1 is an architectural overview of a network environment supporting a data management and evaluation service according to an embodiment of the present invention.

FIG. 2 is a block diagram illustrating components of the software of FIG. 1 according to an embodiment of the present invention.

FIG. 3 is a basic screen shot of a template used as a basis for evaluating available data relative to performance criteria.

FIG. 4 is a block diagram illustrating basic interaction flow of the service of the invention.

FIG. 5 is a process flow chart illustrating acts for entering data for a snapshot record according to an embodiment of the present invention.

FIG. 6 is an exemplary screen shot of a snapshot data entry interface according to an embodiment of the present invention.

FIG. 7 is an exemplary screen shot of a report configuration interface according to an embodiment of the present invention.

FIG. 8 a process flow chart illustrating acts for creating a report according to an embodiment of the present invention.

FIG. 9 is a tabular display that illustrates performance reporting results by category and measure according to an embodiment of the invention.

### DETAILED DESCRIPTION

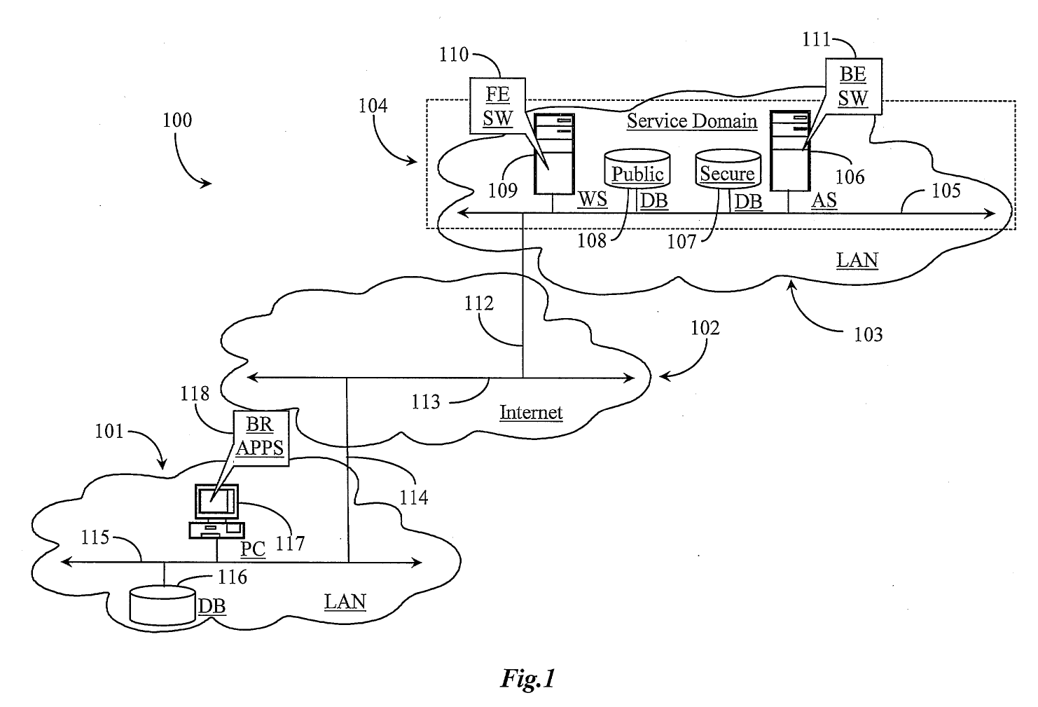

FIG. 1 is an architectural overview a network 100 supporting assessment, venture or project management service 104 according to an embodiment of the present invention. Network 100 includes a local area network (LAN) 101 enhanced for Internet connectivity. LAN 101 may be an Ethernet or some other LAN description as long as it supports Internet connectivity. LAN 101, also illustrated herein by a LAN backbone 115 has connection to an Internet network 102 via a network access line 114.

Internet 102 includes an Internet backbone 113 extending therethrough. Network backbone 113 is representative of all of the lines connection points, access points and equipment that make up the Internet network as a whole. Therefore, there are no geographic limitations to practice of the invention. Internet 102 may be the World Wide Web (WWW). Network 102 may instead be a wide area network (WAN) such as a corporate private network without departing from the spirit and scope of the invention.

A second LAN 103 is illustrated within network environment 100. LAN 103 may be an Ethernet network or some other type of LAN. LAN 103 is further defined in this example by a LAN backbone 105. In this example, a service host, or the entity providing services according to embodiments of the present invention, maintains LAN 103. A client subscribing to the service of the present invention maintains LAN 101.

A service domain 104 is illustrated in this example and provides the services of the present invention, Which are made accessible to clients operating from remote network locations like from LAN 101. It is noted herein that the presence of LANs 101 and 103 are not specifically required in order to practice the invention successfully. The use of LAN networks reflects only that the present invention may be practiced in terms of service and in terms of network participation from a remote LAN network. Likewise, single clients, not LAN connected, may access the services.

LAN backbone 115 supports a client computing station (PC) 117 via an active LAN connection. Computing station 117 may be a desktop appliance or it may be a cellular or digital communications device without departing from the spirit and scope of the present invention. In one embodiment, station 117 is a personal desktop computer hard-wired to LAN backbone 115. In another embodiment, the device is a computer-enhanced telephone or hand-held computer operating wirelessly. Examples may include a personal digital assistant (PDA) like a Palm Treo™, 3-Generation (3G) telephone, or some other network capable appliance. The only requirement is that the device supports a browser, and Internet access capability. LAN 101 also includes a database (DB) 116. DB 116 holds data relative to the client. In a business embodiment represented in this example, LAN 101 may be that of a business client and DB 116 includes any business data pertinent to that client such as sales data, data about partners, contractual data, collaborative data, and any other important company or business data that the client relies on.

In this example, station 117 is a personal computer (PC) and is running a network browser (BR) and other applications (APPS) 118. Other applications may include such as Microsoft Word™ or Excel™, Acrobat™, Corel Word Perfect™, Microsoft PowerPoint™ or other applications from which data may be supported by the system for data migration. In a preferred embodiment, data may be entered into, imported into, and exported from such applications that may be supported by the software of the present invention at the service side of the solution.

LAN 103, further defined by backbone 105, includes a service domain 104. Domain 104 is representative of an entity that will provide the services of the present invention to clients whom subscribe to and in many cases may configure their own services. In this example, an operator of PC 117 may be assumed to be a client of services offered through service domain 104.

In one embodiment, a business client hosting LAN 101, PC station 117 and DB 116 may become a subscriber to data services offered by service domain 104. Service domain 104 is a third party data management service in a preferred embodiment. Domain 104 includes a Web server (WS) 109 supported by backbone 105. WS 109 functions as a client interface where clients may log-on and become subscribers. WS 109 also provide other services such as portal services for the client including a personal and secure Web interface from which the client may perform a variety of tasks.

WS 109 has front-end software (FESW) 110 provided thereon and executable there from. FESW 110 includes at least one personalized client user interface from which clients may access tools, configure services, order reports, set up project data tracking, and the like. WS 109 functions as a first contact point between the client and domain 104 and as a client server for using the services of the invention.

Domain 104 includes an application server (AS) 106 for performing background tasks transparently to the client such as data calculation, report generation, periodic data updates, and so on. AS 106 has back-end software (BESW) 111 provided thereon and executable there from. BESW 111 includes all of the necessary logic for carrying out the services available to the client and for making current information available to the client accessing services through WS 109. It is noted herein that FESW 110 and BESW 111 may both reside as a single software package provided on one machine without departing from the spirit and scope of the present invention. In this example it is distributed over two machines to help clearly explain separate functions of the software.

Domain 104 further includes a public data repository or database (DB) 108 and a private or secure database (DB) 107. Public DB 108 holds data that all of the business clients of domain 104 may access. Secure DB 107 holds proprietary client data that may only be viewed by authorized subscribing clients wherein that data is relevant to the accessing client.

The main service of the present invention involves empowering business clients to define data models and to set up definition, tracking and reporting on activities carried internally and those involving partners of the subscribing business. For example, a client may be a manufacturer that has several resellers deployed regionally to sell products made by the manufacturer. The client then has a vested interest in maintaining the performance levels of those resellers. The client operating PC 117 and software 118 may log into WS 109 and register for certain services.

The client may help to or may totally configure those services according to certain performance levels expected of those resellers. Service domain 104 provides among other services, performance level tracking and based on the expectations of the client. For resellers, parameters that the client may want to compare among the resellers may include sales volume tracking, commitment level definition and tracking, internal business health information for the resellers, reliability statistics, delivery performance levels, and a host of other categories that serve as measurements of the value of that partner, in this case, a reseller.

In practice of the present invention, a client logs into WS 109 and sets up a service relative to data that the client wishes to use as an ongoing grading or evaluation criteria. In one embodiment, the client provides one or more templates that the system will access to generate output. The client may provide categories and data descriptions for those and may establish and describe measures for each new category and anchors for each measure. The system of the invention takes static data from the client and periodic performance data provided by the client to generate reports, performance snapshots, and to provide predictive analysis and forecasts of future performance levels if desired by the client. For the purpose of discussion, a category is a broad measure such as “overall sales”. A measure within a category may describe or define a portion of that category like “sales of replacement parts”. A measure may be tied to a performance level scheme such as “below commitment”; “at commitment”; or above commitment” for a reseller, for example.

Once basic configuration is complete, and the client has populated one or more instances of a template with at least an entity and time period, the user is ready to receive periodic reports including snapshot views of performance relative to specified periods or to compare performance of multiple entities for a single period, or other options. The client data and performance scheme is held for the client online in secure DB 107. As time progresses, the client may upload records indicating performance activities for the partners, such as resellers, for example, that the client is tracking. The service may import data into existing templates and into DB 107 from any supported electronic files the client may use such as Excel, QuickBooks, or some other sales order database, shipping record or the like. In one embodiment, the service may have limited access to the client data store and may capture information almost as it becomes available.

In one embodiment, the system may have access, through one or more network server adaptors to third party data management services that the client subscribes to like a financial management company, or an outside sales consulting firm. Records from these services may also be imported or uploaded to the service for use in evaluating entities. Likewise, certain entities charged with keeping their own hard records may also be considered a data source of data that may be used by the system.

The next time the client logs into server 109, the client may wish to generate a report or to order a snapshot record. The report templates are system templates that are provided by the host. The reports are generated based on the available data, the selected type of report, and whether the reports will be a graphic report, a text report, or a combination of graphics and text. Likewise snapshots may be ordered that provide summary information or more granular information down to all of the details. A report type may simply be a “sales summary” for a period including performance level “scoring” of all resellers, for example. More detail about reports and snapshot records will be provided later in this specification.

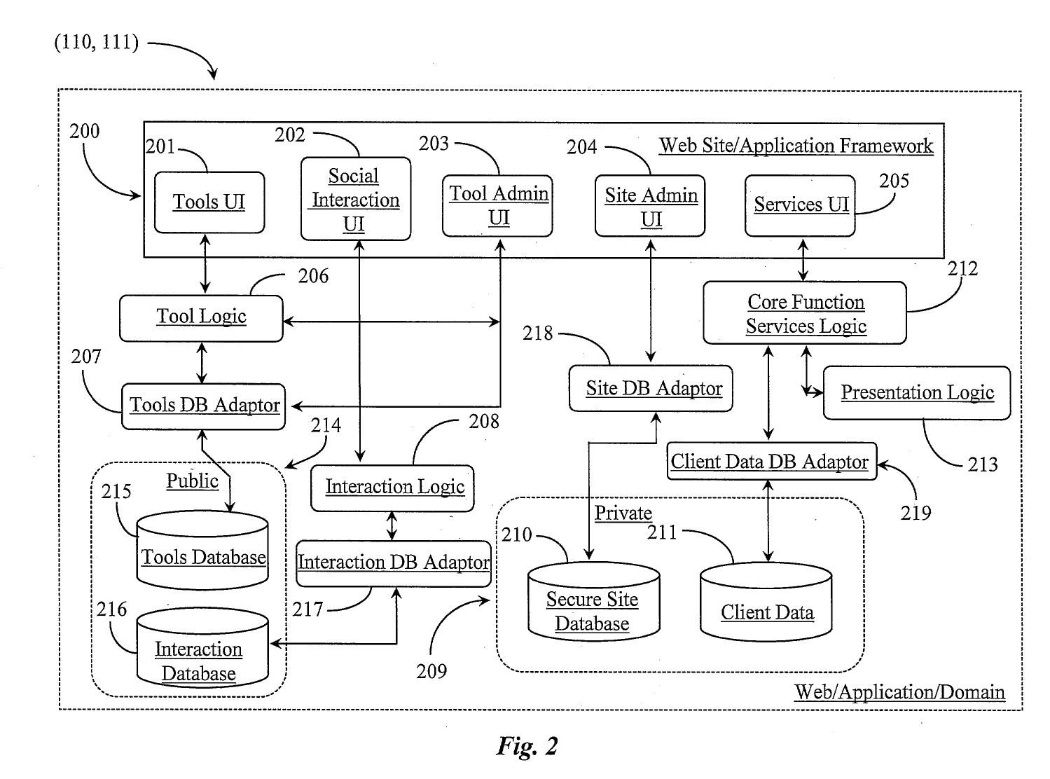

FIG. 2 is a block diagram illustrating components of software 110 and 111 of FIG. 1 according to an embodiment of the present invention. Software 110 and 111 may be provided as a single package of software running on a single machine without departing from the spirit and scope of the present invention. In this example, the software of the present invention is hosted on a network like LAN 103 of FIG. 1 and is accessible through the Internet via server/client communication protocols using hypertext transfer-based protocols (HTTP) and other Internet communication protocols as may be required such as file transfer protocol (FTP), unified datagram protocols (UDP), wireless application protocol (WAP), extensible markup language (XML) and others.

A Web site and application framework 200 is illustrated and includes several user interfaces (UIs) that enable authorized access to the various tools and functional services. Framework 200 may be used to provide the services of the invention through Web application and server software over a WAN like the Internet network as illustrated in FIG. 1. A tool UI 201 is provided within framework 200 and is adapted to enable clients to have access to tool logic through task performance actions initiated from a secure Web interface. Tool logic is illustrated herein as tool logic 206. Tool logic 206 is, in one embodiment, one or many Web-based application scripts that contain the logic and functionality for performing form updates and calculations to derive new data such as new category measure values and the like. The scripts contained in tool logic 206 are, in a preferred embodiment, executable scripts and may be used to pass data to a tools database adaptor 207. Tools database adaptor 207 communicates with a tools database 215 within a public area of the host database system. Tools database 215 contains all of the created tools, including mini executable scripts used for enabling functions and tasks initiated through the UI, which may be a Web interface. Moreover, clients may create and maintain proprietary scripts and tools in their secure database area of the service.

In one embodiment of the present invention, tool logic 206 may be accessed by clients through tools UI 201 for the purpose of creating customized templates or other data weighting forms that provide specific calculated values based on available data. In one embodiment, the entity hosting the service will provide a basic tool set library that is publicly available to managerial users of clients responsible for creating the company performance standards and weights that will be used to evaluate external partners like resellers or distributors, for example. Clients may also use the system to grade and evaluate internal segments of the company or other items of interest. As new tools are created, some tools may be rendered obsolete after a time. Obsolete tools or tools that may no longer be valuable to the system due to improved technologies may be purged from the system by service administration personnel authorized for the task. In this way, the tools database may grow through collective experience of many represented companies subscribing to the service as clients. At the option of each client, tools can be made available in public areas so that other clients can use them or adapt them to their own purposes.

Another important aspect of the service is to provide a quasi-professional social interaction experience for the personnel of the subscribing companies. Therefore, framework 200 includes a social interaction user interface that enables personnel to access various services like chat, collaborative white boarding, posting boards, categorical or general forums, and many other publicly accessible resources. The companies or professionals who will use them may customize social interaction capabilities through social interaction UI 202. For example, one client may whish to limit social interaction to technical forums. Other companies may wish to utilize a full range of social interaction services. Social interaction services may be enabled by social interaction logic 208, which contains all of the applications that may be used in the interactions between personnel of a single client or between personnel of collaborating clients and so on. The level of structure for different services may very widely. For example, a weekly chat discussion may be scheduled that is open to all clients where a discussion topic is strictly observed and only authorized personnel from each client may participate. As well there may be an open and unstructured public posting board. There are many possibilities.

Interaction database 216 contains interaction logic (applications and utilities) and interaction records, if desired. Interaction records may include documents, chat transcripts, forums discussion transcripts and so on. In one embodiment, interaction database 216 contains a public library that includes templates shared by clients subscribing to the service of the invention. These templates may be accessed by any subscribing client and modified by the client for use as a basis for tracking, monitoring, and reporting. Such shared templates created by clients and then made available for access by other clients may be stripped of actual data about real entities like resellers or distributors, but may retain the entity type indication including suggestive rules for reporting and performance level schemes. Interaction database 216 is accessible through an interaction DB adaptor 217. Any information contained in the database including templates is publicly available to subscribers of the service. In this way, clients may customize their own social interaction capabilities for their service and any templates for data monitoring, entity evaluation, and report generation.

Framework 200 includes a site administration UI 204 that enables authorized service site administrators access to a secure site database 210 through a site database adaptor 218. Secure site database 210 contains Website data and logic used to create the core look and functionality of the service portal and the back-end server functions and capabilities. All data, tools and applications that represent the Web service including the framework may be stored in database 210 in a private area of the system storage illustrated herein as private storage 209. Area 209 is accessible only to authorized personnel. Private storage 209 also includes a client database 211. Client database 211 is adapted to warehouse all proprietary client information and data used to create reports and periodic snapshots according to the client business model and templates employed by the client. Client data 211 may include security roles for authorized personnel, password and personal identification number (PIN) information, billing information, user identifications, and other data required to enable proper security and billing to clients.

Other types of data that may be stored for clients in client DB 211 include data that clients submit to the system like sales records, quality records, shipping records, accounting records, and other hard data that is accumulated over the course of doing business. Such data may be used by the system to monitor client partners, distributors, resellers, retail locations, and so on. Most of this type of data may be imported, or uploaded to the system periodically from locations of origin using service-supported tools for importing the data from client local database applications, spreadsheets, financial accounting utilities, or the like. For example, a sales order database maintained by a client with 3 resellers may identify all of the shipped sales of those resellers whereby each shipped sale in the record is identified as to the particular reseller who completed the sale. The service may import the entire record for a period and sort the identified sales by the correct resellers when calculating a measure “total sales for period” for each reseller. Likewise, other types of records may be uploaded and parsed by the system of the present invention such as QA records, product returns, complaint histories, sales campaign activity records, and so on. In many cases, data will be entered manually, and the rationale for performance anchor selection will be supported by attaching relevant business documents such as meeting notes, sales records or other. In this way, the invention ties best practices tools directly to the performance management system.

Data held within client database 211 is not directly accessible to any clients without permission except through appropriate snapshot and report generation. In this way accountability of the client and integrity of the data is maintained by the service. Some data held within client DB 211 may be voluntarily submitted to the service by the entities that the client is monitoring, tracking, and periodically evaluating. For example, a client may maintain several distributors that are each responsible for submitting their own hard data related to activities performed on behalf of the client according to rules developed by the client and enforced as a condition of doing business with the client. This aspect represents a distributive model where the client is the subscriber to services and adds certain entities to the service so that those entities may be properly monitored and evaluated according to the business model of the client.

Framework 200 includes a services administration UI 205 that is adapted to enable authorized service personnel to create and maintain core functions and services offered to client subscribers. These functions and services relate to back-end server functions, capacities, database functionality, and other like issues. Through a secure Web interface, a service person may access core function and services logic to make system changes, fix bugs in the system, make changes or initiate manual updates to client data, expand database capabilities, and so on. Core function and service logic 212 may communicate with client DB 211 through a client DB adaptor 219. Part of the core services that may be implemented and modified are presentation logics illustrated herein as presentation logic 213. Presentation logic 213 contains the adaptors converters, and other utilities that enable smooth data importing and exporting into client interfaces according to preconfigured client preferences. The presentation logic may use information that is template based and/or information submitted with a client order such as an order for a specific type of generated report.

It will be apparent to the skilled artisan that there may be other components present in the framework illustrated here without departing from the spirit and scope of the present invention. In this example, the service of the invention and features of the service are Web-based. In an alternate embodiment, the service of the invention may include hardware and software enabling telephone access such as ordering reports over a voice line connecting the client to a telephone system access point like an interactive voice response unit connected to an application server. In such an embodiment, a user may order a report via voice line and have the report faxed to a fax number or emailed to an email address, or otherwise delivered to one or more contacts like associates, meeting entities or the like. In the Web-based example, a client may order report generation and distribution as well by including the particulars in an electronic order form or field interface. In one embodiment, the client may order a series of timely reports for a number of periods where the application generates a report automatically for each period until the client terminates the order or modifies it.

The Web-based service described herein may be operated as a third party data tracking and management service. The service of the invention may also be packaged as a turnkey service package for use by consulting films offering services to their clients. One advantage of practicing the invention in this way is that the consultant may help evaluate proper associations for clients and may identify certain trends, practices, or collaborative opportunities that may otherwise go un-noticed. The system uses a simple core method for evaluating entities from a client perspective.

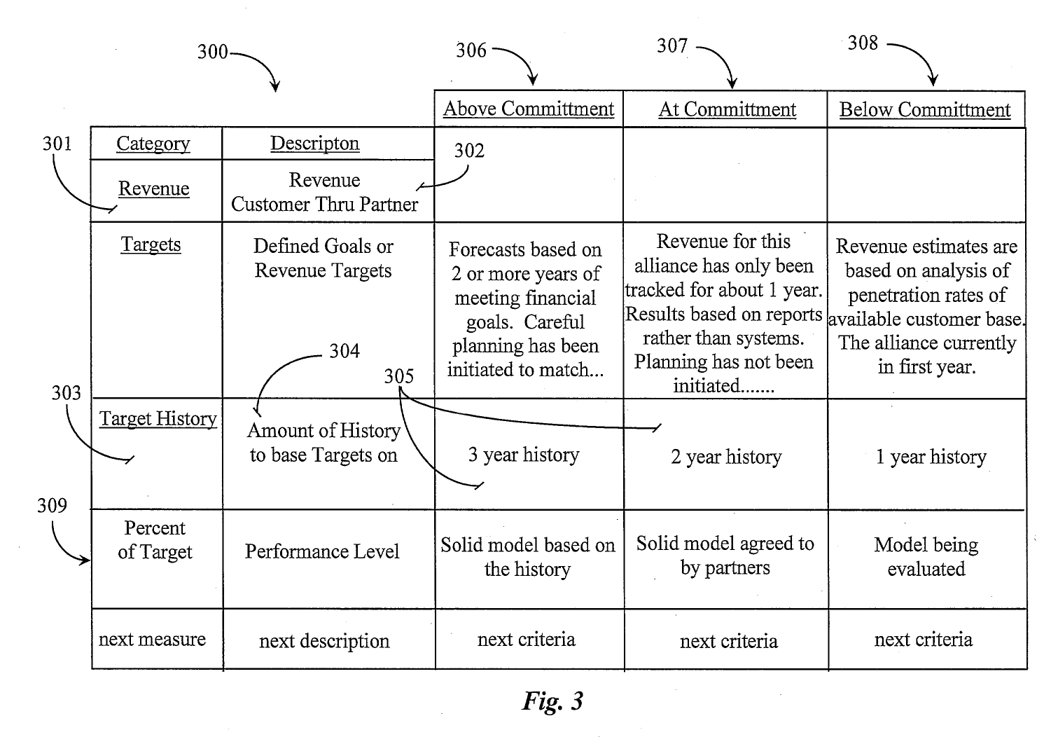

FIG. 3 is a basic screen shot of a template 300 used as a basis for evaluating available data relative to performance criteria according to an embodiment of the present invention. Template 300 may be in the form of an Excel™ spreadsheet, or any other supported word processing format. Excel is chosen as an example in this embodiment only because of its popularity and synergistic field and data organization properties. Many other applications may be used to create a template useable by the service for evaluating data.

By definition, a template provides the basic or core rules for performing some task. In this embodiment, the template outlines a scheme for defining categories, category measures, and performance criteria. The exact categories and measures including the performance rating criterion are arbitrary and may very widely from client to client. The example presented in this embodiment should therefore not be construed as any type of limitation to the practice of the present invention. In a network-based data management service such as the service of the present invention, a ranking module may be provided as an executable object associated with the template. The performance ranking module may include a class object defined as a category, a class object defined as a category measure, a class object defined as measure performance anchor, and two or more performance level objects of descending or ascending hierarchy none equal in value to the other when defined, in a preferred embodiment, by subscribing clients who personalize the module objects by adding their own attributes to them.

Template 301 has columns and rows, which represent familiar components of any table. A first column reading from left to right is a name column for categories and category measures. A category is a broadly defined area of activity. In this example, a category Revenue 301 is named in the column at the first row field. A next column contains description fields that describe the categories and measures. For example, the category revenue is defined in the template in an adjacent field 302 as the revenue generated by the client through a specific partner. This category of revenue is not broadly defined as would be the category “total client revenue through all partners”, but for purposes of discussion, the category revenue is limited in this case to the revenue generated by a single partner.

Each template may have one or more than one separate category. Likewise, each category may have one or more measures. In this example, the first field in the second row under the first column is a measure “Targets” of the category “Revenue”. Another measure of revenue is “Target History” 303. Each measure may have a measure description in an adjacent field. In this example, a measure description 304 is associated with the measure target history 303. The definition used in this example is the amount of history for which target revenue amounts are based on. Measure anchors 305 are closely associated with a performance scheme. For example, there are 3 levels of performance in for template 300. These levels are “Above Commitment” 306, “At Commitment” 307, and “Below Commitment” 308.

Therefore, for the measure Target History, which is defined as the amount of history for which to base the revenue targets, the top measure anchor 305 is set at a 3 year history and associated with the performance level 306 defined as “Above Commitment”. A measure anchor 305 that is weaker is defined as a 2-year history to base the target on and is associated with the performance level 307 defined as “At Commitment”. The third measure anchor for the measure target history is defined as a 1-year history for which to base the target revenue on. It is logically associated with the lowest performance level 308 defined as below commitment. It is noted herein that measure anchors may include rather lengthy description in narrative form referred to herein as “soft data”. The anchor describes the criteria required of a certain performance level for that measure.

Another measure in this example is measure 309 defined as the “Percent of Target”. The measure is defined in the next field over as the level of performance relative to the target. The associated measure anchors define the criteria needed to achieve one of the 3 available performance levels 306, 307, or 309. Again, the anchors describe how the soft data must be evaluated in the context of the performance rating scheme.

In the present embodiment, templates are created by clients, although they may be borrowed from the public library described further above. Templates, in one embodiment, have 4 to 8 categories, each category has 2 to 6 measures, and each measure has 3 or 5 anchors. In other embodiments, other numbers may be used. In this embodiment, all measures share a common set of performance levels, and a common number of specific measure anchors. A measure anchor or performance anchor describes relative weaker or stronger performance measure for a category measure. An anchor is tied to the performance level scheme used. The performance scheme where there are separate levels may be equated to numerical values. For example, performance level 306 may be assigned the numerical value of 5 while the performance level 308 may be assigned the numerical value of 1. Performance measure 307, then would fall somewhere in the center, perhaps assigned the value of 3.

Templates are useful for organizing performance measurement criteria. In this embodiment, the template is an Excel spreadsheet. There may be other valid approaches to organizing the performance measurement criteria. Templates may include other factors, such as measure weighting, in order to better describe the relative performance of measures within a category, among other objectives.

In one embodiment of the present invention, a formula for calculating performance values for measures and categories is provided. When all of the measures in a category receive a performance anchor level of 3 or more, the category value (numerical) equals the sum of the square of the average of the measure values, divided by the number of measures in the category. If one or more measures receive a performance anchor level below 3, the category receives a value equal to the square of the next highest measure score received. To elaborate, under the formula if all measures receive a value of 5, the category measure=25. If all measures receive a value of 3, the category measure=9. If one measure receives a 2, the category measure=4. Using this approach, it is possible to amplify the calculated gap between poor and excellent performance (lowest and highest level) to improve relative performance assessments. This approach may be applied to many different performance-tracking situations without departing from the spirit and scope of the present invention. The formula may be presented as the following formula=IF(L108>0,M109,SUM(L110:L115)*1.1) that works with an Excel™ spreadsheet-type architecture.

L108 is a spreadsheet cell that counts the number of measures from lines 110 thru 115 in this example having a category with a value less than 3. M109 is the value for the “problem score” for the category, such as 4 on a 25 pt scale. SUM (L110:L115) is the sum of the squares of the measure values for the category. 1.1 is a leveling variable based on the number of measures in the category.

Using template 300, a client may customize the way partners or other integral components of the organization are evaluated or “scored”. A performance tier structure like the one illustrated here may be used as the performance scheme for all of the categories scored for each entity the client has added to the service for evaluation. An entity may be a reseller, a manufacturer, a distributor, a shipping department, a quality control department, a sales force, or any other external or internal definable entity that performs some function for the organization. A performance scheme may simply be expressed in numerical values rather than having a specific set of performance names. Likewise the names may be excellent, fair, and poor, instead of above, at or below commitment. The term commitment here implies a commitment made by the entity being tracked and evaluated. The category may be sales and the entities may be regional sale teams competing with each other. A sales target may be set for all of the teams and the performance scheme may be defined as exceeded target, met target, or failed to meet target. There are many variant possibilities that depend in part of the nature of the business, categories defined and the depth or granularity evaluation desired.

Hard data may be evaluated solely on its existence and may be related to some category like overall sales. Obviously, several entities may be evaluated based solely on their performance in number of sales made for a given period. However, this information does not necessarily point out to a general manager or other high level planner which entities are necessarily the best for the company. The highest seller may have the most complaints and returned products. Therefore, one goal of the present invention is to combine hard and soft data, even data that may be speculative or opinionated into the evaluation process. Measures are scored contributing to an overall category score for each category thus leading to a final overall performance score for the entity being evaluated.

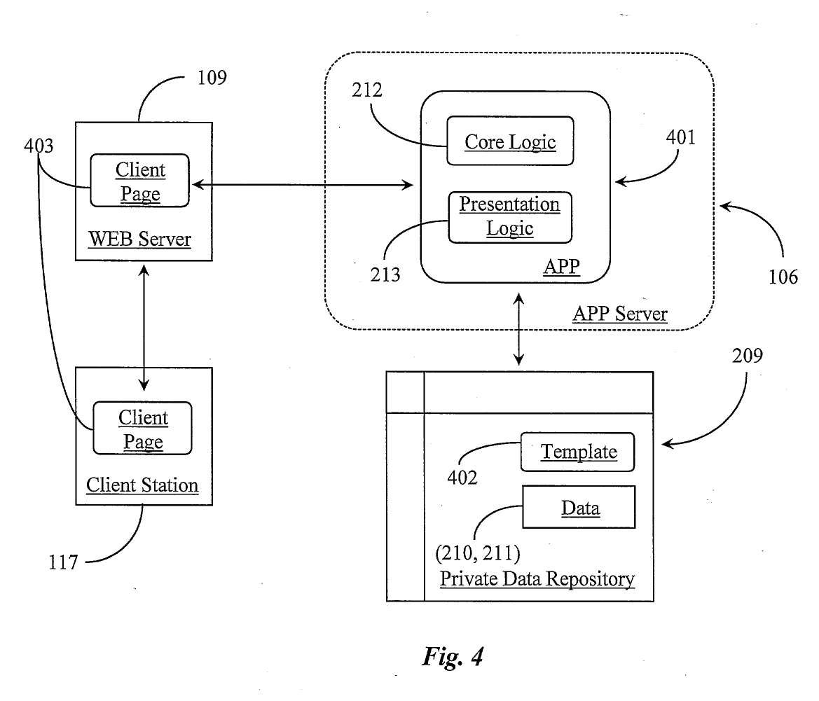

FIG. 4 is a block diagram illustrating basic interaction flow of the service of the invention. Client station 117 is leveraged to access Web server 109 through secure authentication of the user operating the station. Assuming the client is registered and known to the system, a personalized client page 403 is served to the client. Client page (user interface) 403 displays on station 117 typically in a Web browser. The client interacts with page 403 to cause some action like ordering a snapshot of one or more added entities that the client is tracking and that the system already knows, for example.

The Web server 109 communicates with application server 106. Application server 106 is running an application 401 that leverages core logic 212 and presentation logic 213 to render some useable output. Data repository 209 includes one or more templates 402 supplied by the client, and secure data, in this case site data and client data. The application 401 retrieves available data from repository 209 and performs certain calculations, if required according to a template 402 previously submitted by the client and identified in the client order as the template to base calculations from.

Application 401 performs the required calculations on the data retrieved from repository 209 and leverages presentation logic to form a graph or table or other type of reporting output based on client preference. The output in whatever form supported and requested as preferred by the client is served to the Web server where the client may access it and download it. In one embodiment, the output from server 106 bypasses the client interface on the Web and is instead sent to some other venue such as an email account or fax number, or some other destination or multiple destinations. As long as the client has set the destination addresses in the-order, the report may be delivered directly to those locations. In one embodiment, a copy of the report or snapshot is saved to client data (211) by default and may be displayed as well on the client interface as a hyperlink to the actual report. The method of data organization in repository 209 may very, but a relational database using a normalized database schema is sufficient for the purpose.

The client template that serves as the basis for the report generation may be an Excel™ spreadsheet template. The template may include entry fields for a template name, various categories, measures of those categories, performance level ranking values, measure anchors, and in some embodiments, additional weighting factors if desired. Data may be input into the template in spreadsheet cells. The template may-be created off line and uploaded to the system using a form and import script, or it may be created online using a Web interface. A client may have multiple templates saved in repository 209 in client data 211. When ordering a snapshot performance record for an entity the client need only identify the template to be used by the system. There are many possibilities. Application instance 401 may rely on an environmental data set including but not limited to user roles, actual users, entity classes, entity regions, actual entities, and periods for data aggregation and calculation. Information such as was just mentioned may be entered into an interface at the time of requesting a report, or it may already be loaded, as an additional template or on the original template.

It is important to note herein that a snapshot record may be ordered based on template criteria for virtually any period of time. A snapshot is generally a record of performance activity and ranking that can be automatically delivered on a repeating basis using the same template criteria. A full report generation may include information that is basically fed into the system at the time of the request. A snapshot may be based on a specific template and reports performance for some period or periods. It is generally consistent with an entity, and may include data capture fields and fields of data that are calculated at the thine of generation of the snapshot. A snapshot record may store information such as present performance and future performance commitments, performance rankings, and related documentation, in many forms. A snapshot record may be created after the supporting template and environment data is available in the system database.

It is important to note herein that as long as the templates and supporting data is available, comparison reports may be generated that rank entities based on a combination of factors defined in the templates as categories and category measures. It is also important to note herein that more than one performance level scheme may be used in ranking entities according to performance in various categories. Using the system of the invention, a user may obtain information with granularity down to a single entity and a single measure and may work up the hierarchy to include more measures categories and entities for comparison and value ranking according to template criteria or soft data.

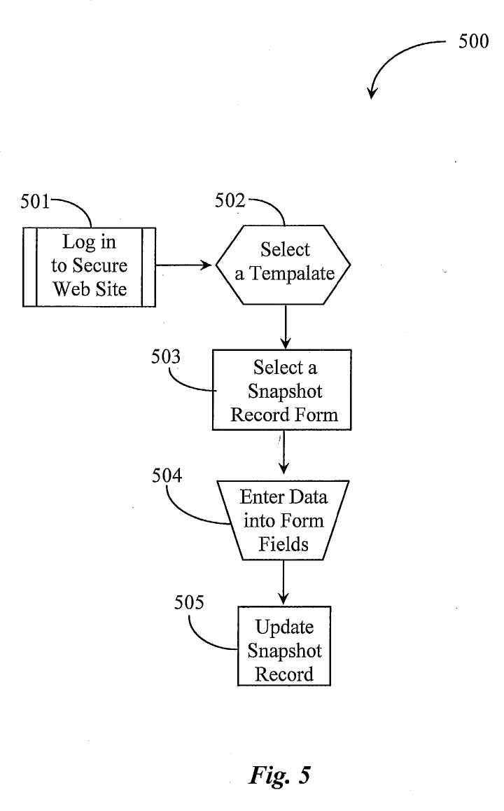

FIG. 5 is a process flow chart illustrating acts 500 for entering data for a snapshot record according to an embodiment of the present invention. At act 501, a user authorized as a subscribing client logs into a secure Website and accesses a personalized user interface, which may be browser based in one embodiment. Act 501 is exemplary only and is representative of just one of more than one way to access the service of the present invention to order a snapshot record.

In act 502, the user selects a template for which to base the snapshot on. Template selection may be accomplished using a drop-down or scrollable menu listing available templates. At act 503, the user selects a snapshot record form. In this act, the user, navigating the form may select an existing snapshot record to modify or the user may create a new snapshot record. Once an existing snapshot record is imported into the form fields of the snapshot record form, the user in act 504 may update those fields. Likewise if a new snapshot record is being created, such as for a brand new entity, the user will populate all of the required fields. The user may navigate fields adjacently or he or she may skip fields by using a metrics navigation feature of the form.

At act 505 the user submits the entered data updating the existing snapshot record or creating a new snapshot record. It is important to note herein that the functions of calculating and populating the performance ranking fields of the record are not illustrated here because they are automated features that leverage existing data from the repository or, in some cases from accessing an outside service. For example, a service that provides accounting and job management or fulfillment services for an entity might be accessed for data for the period or periods entered into the snapshot record form. Taking an existing form and simply changing the entity name on the form may be sufficient to render a new ranking calculation for the included measures and categories. A user may also apply more than one entity name in a list separated by commas, or as a created group listing represented by an icon or text descriptor. In this way individual snapshot records may be created for all of the included entries. In this case, all of the measures and categories are identically described and are ranked under a common performance level scheme.

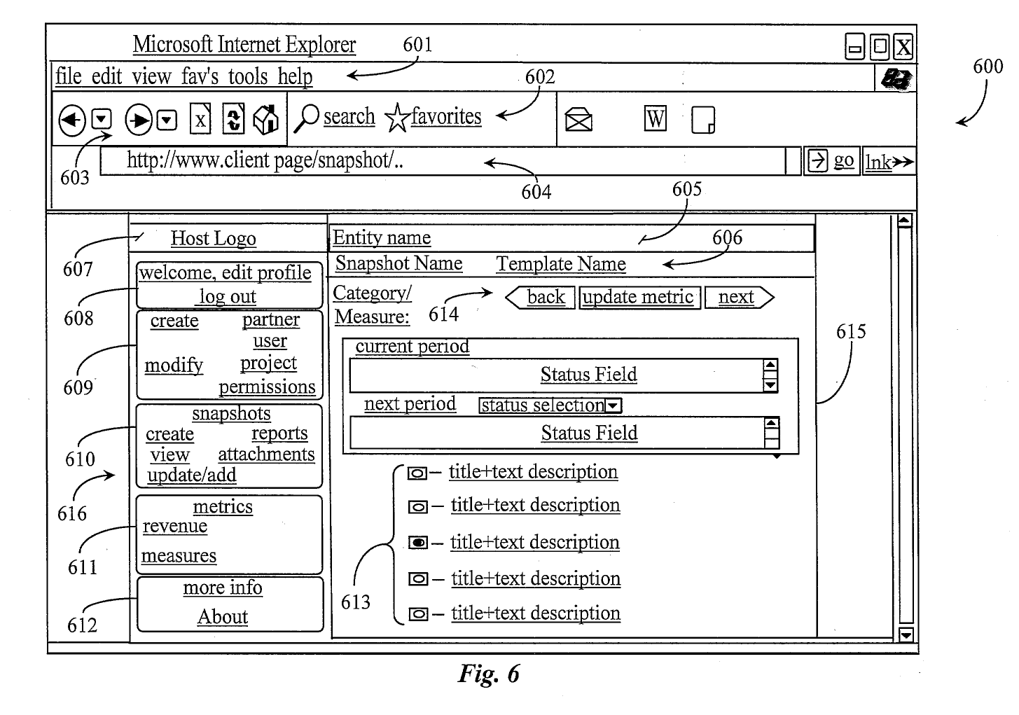

FIG. 6 is an exemplary screen shot of a snapshot data entry interface 600 according to an embodiment of the present invention. Interface 600 is a browser-based interface analogous to client page 403 of FIG. 4. The particular form displayed, in this case, is a snapshot data entry form 615 adapted to enable the user to create new or to modify existing snapshot records. In this example, interface 600 is of the form of a browser screen having the familiar browser tool bar options 601, the familiar navigation and task icons 603, search and bookmark options 602, and the familiar browser address navigation field 604.

In this example, snapshot entry form 615 is illustrated within the browser window. Interface 600 includes a side bar area 616 that contains various navigation and task performance options. Side bar area 616 includes a place mark for displaying the name and logo 607 of the host entity providing the services interface. Side Bar area 616 includes a welcome section 608 that welcomes the user by name in some cases, enables that user to edit the current user profile, and provides an option for logging out of the system.

There is a task performance section 609 within side bar area 616 that includes task options create a new user, a new partner, a new project, and new permissions, or to modify existing users, partners, projects or permissions. For the purposes of discussion, permissions are a set of configurable rules that govern access to resources for client personnel. A user is an authorized person that may access and use services. A partner is an entity associated with the client like a distributor, reseller, manufacturer, or other.

A task options box 610 is provided within area 616 and contains task options related to snapshot management. There is an option for updating snapshot records creating snapshot records, generating reports, adding attachments, and so on. The option creating or updating snapshots would be one that invokes snapshot form 615. A task options box 611 is provided for enabling navigation according to metrics such as categories and measures. All information box 612 is provided for enabling users to acquire more information about the host, service, subscription, account data, and so on. One with skill in the art will appreciate that navigation and task performance options illustrated in the context of a browser-based interface may be presented in any number of formats, groupings, or areas on the interface without departing from the spirit and scope of the invention. Arrangement of the interface is a matter of design and space consideration. Links to other pages, action icons or graphics, text links, and other options may be provided.

Snapshot form 615 has an identification panel 605 that includes a snapshot name and a template name. The template name identifies the template that the snapshot record is based on. The snapshot name may be the name of an existing snapshot being modified, or a new name given to a new snapshot record being created. Form 615 also has a title bar 606 that indicates, for example, which category is being created or modified and has a namespace for that category. If a user navigates to another existing category, that category name will be displayed in title bar 606. Form 615 further includes a measure namespace associated with the category such that any measure displayed in a measure of the current category associated to it according to the template hierarchy described earlier. In one embodiment, each category and measure displayed on form 615 may also be accompanied by the text description of the category and of the measure. Space prevents entering such description in this exemplary form.

Form 615 includes metrics navigation and update utility options 614 that include in the grouping, a back button, an update metric button, and a next button. A user may navigate the categories and measures referred to as metrics, and may at any time select update to initiate an update to that measure or category. In one embodiment there are associated task icons (not illustrated) provided on form 615 wherein a user may select one of those to jump to a related task. For example a user may choose to attach a supporting document or other electronic file by selecting a “paperclip” icon for attachments. In one embodiment, the user may view a “spider” report by clicking an appropriate icon, or view a tabular report by clicking an appropriate icon. A skilled practitioner in the arts will observe that the choice and placement of such supporting task icons is arbitrary, and many other such tasks are possible.

Form 615 has a series of data entry fields for identifying periods of performance such as quarters, for example, and for inputting soft data describing the status of the entity for that period. In this example, there are 5 measure anchor buttons 613 associated with a title and associated explanation of each performance level. The 5 anchors in this case describe 5 separate levels of relative strength or weakness. For example, if prioritized for strength from top to bottom, the titles may read excellent performer, some strength, meets expectations, developing, and immature. The just mentioned performance levels are merely exemplary. There may be fewer or more performance anchors provided in this example without departing from the spirit and scope of the present invention. In the example of FIG. 3 above, there were only 3 performance levels.

Each performance ranking may include the associated soft description. It is important to note herein that in some cases the measure being updated will automatically have the appropriate anchor level selected because the data is of a numerical nature that is already available to the system, and can be compared to the available performance anchors. In other cases where new “soft” data is being created and submitted where that data and that measure do not have any supporting hard numerical data such as sales numbers, and the supporting data is subjective like editorial reviews or opinions of tactics, for example, an appropriate anchor may be selected by the user and applied to that particular measure. However, in one embodiment, there may be a calculation model integrated with the service model that can interpret soft data and place the data set into a category that is equated to some numerical value that ultimately is equated to an existing anchor that has a performance level description associated with it. Therefore, in one embodiment physically entering an anchor is not required when creating or updating a snapshot record as long as all of the variables pertinent to the ranking decision have been submitted to the system before hitting the update button.

Once many snapshot records are created and stored in the system for particular entities, a user may simply add an entity name to an otherwise blank snapshot record form to calculate a new snapshot record for the new entity based on data that the system already has associated with that new entity for which the record is being created. Snapshot records may be ordered for an entity to repeat calculations periodically taking into account the data that has accumulated since the last calculation. Each new record may be saved for the period ordered such that at the end of a year, for example, 4 records are still available for review, one for each of the quarters of that year. If the period is monthly than 12 records would be accumulated by year end and so on.

A user may navigate the snapshot record within the form. A use may also navigate the record using navigation pane 611 and may invoke sub screens that list, for example, all of the categories and associated measures for the record. Updating the record may include changing the entity, changing categories and/or measures, adding categories/and or measures, subtracting categories and/or measures, changing descriptive content associated with performance anchors, measures or categories, adding or subtracting performance anchors, and associating supporting “soft” data in the form of typed input, voice input (if supported), attached reports, or the like to a measure or category. In one embodiment, version control enables the user to “roll back” to previous measurement models or snapshot attributes.

In one embodiment, modifying a snapshot record is limited to just data that is not available in a pre-existing template that the record is based on. However, in another embodiment, an option may be provided to extend the modifications, for example, to the original template named as the base template on form 615. As another option, the system may allow the change extension to the original template wherein the template is renamed as a new template leaving the original base template unchanged. There are many possibilities for propagating updates throughout the system of the invention.

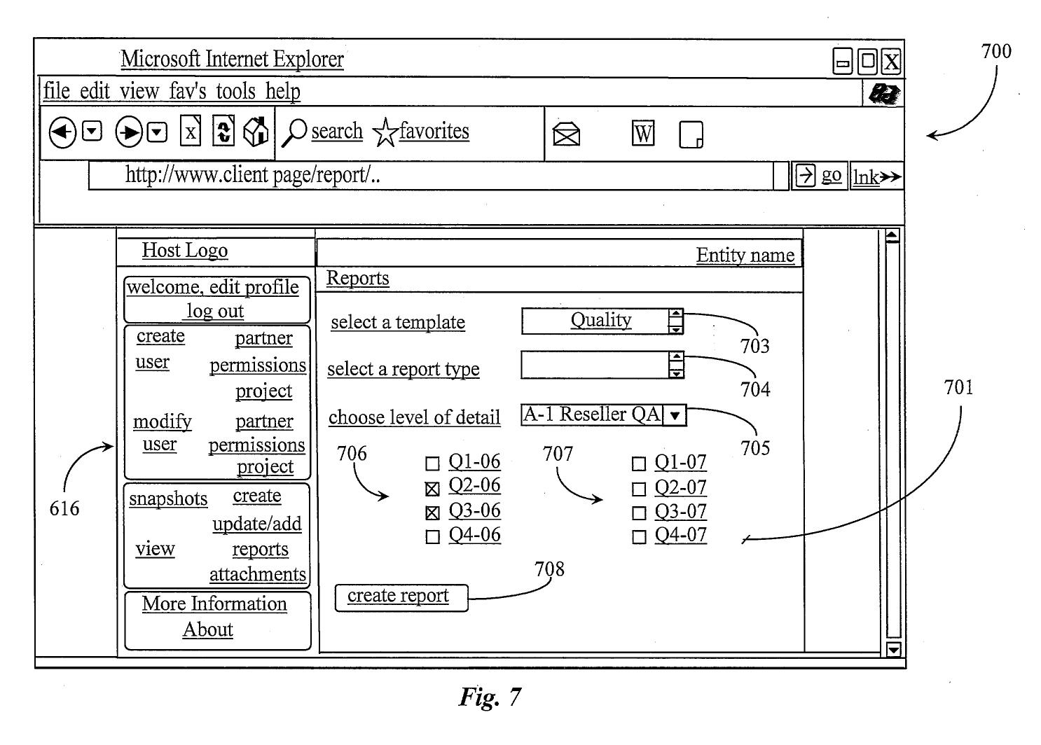

FIG. 7 is an exemplary screen shot of a report configuration interface 700 according to an embodiment of the present invention. Interface 700 is a browser-based interface in this example and has many of the same options as described above in interface 600. Interface 700 has a work window 701 invoked as a result of the user electing to create a report, an option provided in side bar area 610 of side bar 616 described further above.

Report form 701 has a namespace for the entity name or the names of entities the report will cover. A scroll menu 703 is provided and adapted to enable the user to select a template that the report will use as a basis. A scroll menu 704 is provided in form 701 and adapted to enable the user to select the type of report to create. The type of report might be a performance ranking of the entity or of more than one entity relative to one or more categories. In the event of more than one entity and category, the report might be a comparison study that ranks the overall performance of the entities for each category and provides an overall value ranking that suggests the current and future level of value that each entity currently contributes to the company and is expected to contribute in the future.

A scroll menu 705 is provided and adapted to enable the user to select a level of detail for the report generated. For example, the generated report may simply be a summary report showing the overall performance ranking of one or more entities. Likewise details of the report might be ordered visible down to each performance score for each category for each entity covered in the report. Still further, granularity can be achieved down to each measure of each category for each entity. Hyperlinks may be made available in the report that enables the user to call up the actual data records used to generate the report and that enable the user to access any associated documents and soft data that may be associated with the reporting process and ranking decision.

A period selection section 706 is provided that, in this example, lists each quarter of one year (06) for the user to select from. In this case, only 2 quarters, the second and third quarters for the year are chosen for the report. A second period selection section 707 is also provided and has all 4 quarters of the next year for selection. It is important to note herein that in one embodiment the second period selection section 707 may be a future period where hard data is not available for analysis. In this case, selecting future periods can be based on existing commitments, expected performance rankings for those periods based on current analyzed data and trends supported by the current data and by soft data in the system or other methods.

A report generation button 708 labeled create report is provided at the bottom of the form. Invoking create report 708 initiates the report generation process, which includes gathering and analyzing hard and soft data and performing any needed calculations to render the results according to the template selected as a basis for the report. It is noted herein that a report may be based on more than one template if desired. For example, there may be two templates having the same categories and measures wherein one has more performance anchors than the other. In this way a user may order a report using one set of performance rankings and then one using a finer set of performance rankings. When evaluating comparative performance and expected future performance for multiple entities, using a finer performance scale may enable a tie-breaker for very closely ranked entities.

In one embodiment, form 701 includes additional options for specifying the type of graphics for the report and the type of format that the report will be presented to the user. This is supported by the presentation logic described further above with respect to FIG. 2. For example, in addition to static reports like spider graphs, line graphs, pie charts and the like, tabular reports may be created in formats importable to existing programs on the user's computing device like Excel™, Adobe Acrobat™ or Word™. In one embodiment, the system of the invention may generate navigable reports like Power Point™ presentations whereby generated slides may be imported directly into the interface.

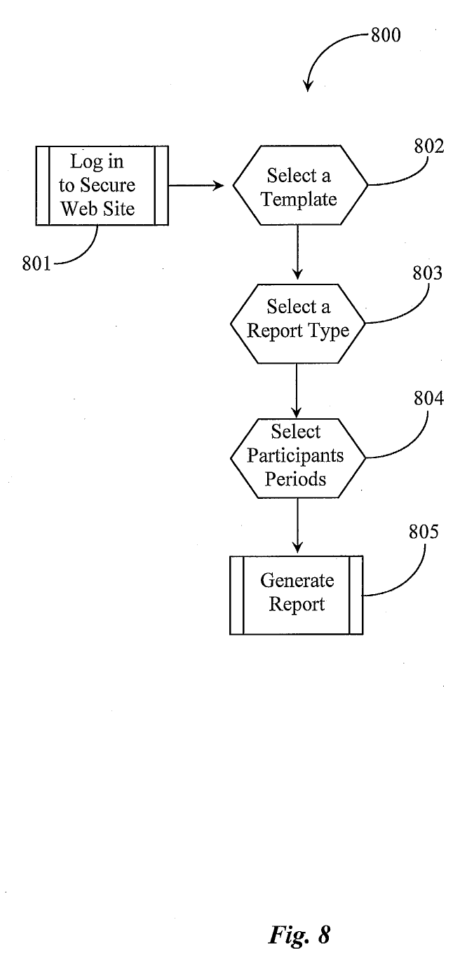

FIG. 8 a process flow chart illustrating acts 800 for creating a report according to an embodiment of the present invention. At act 801, a user logs into a secure Web site and accesses a report generation interface form like form 701 described above. At act 802, the user selects a template. At act 803, the user selects a report type including format and graphics preferences if any. At act 804, the user selects the entities and periods for the report. The periods selected may include future periods for predicting or forecasting future performance expectations. At act 805, the user selects generate report to initiate the reporting process, which may include calculation of results. It is noted here that generating reports does not depend specifically on whether or not there are snapshot records stored for an entity. However, if there are one or more snapshot records, they may be used as hard data to help rank entity performance in one or more categories.

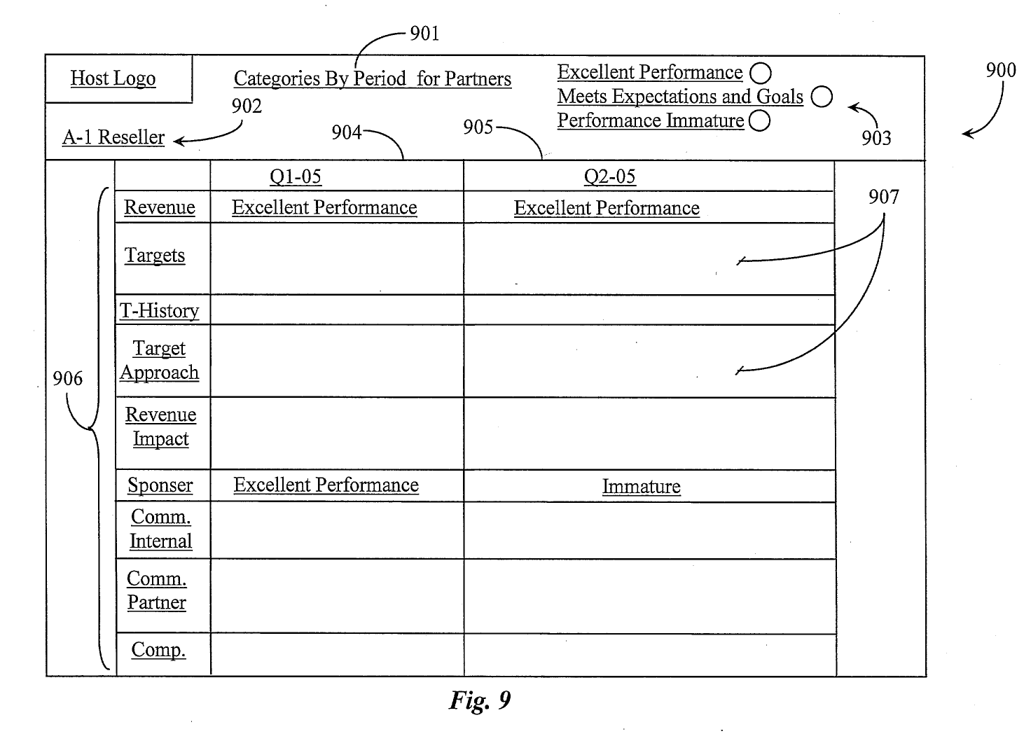

FIG. 9 is a tabular display 900 that illustrates performance-reporting results by category and measure according to an embodiment of the invention. Screen 900 is a report page or display screen that is generated in the reporting process. In this example, report screen 900 is in the form of an HTML-based electronic document that may be displayed in a browser. In one embodiment, the data in screen 900 may be exported to a personal program interface like Excel™. It may be exported as a slide to a Power Point™ presentation or some other personal use application.

Screen 900 has a title name space 901 for accepting a report description, in this case, performance rankings for categories by period for partners. In one embodiment, report screen 900 may be assumed to be a snapshot record created for the periods Q1-05 and Q2-05 for the entity A-1 reseller. The level of detail is categories and measures for each period specified. Screen 900 is scrollable so that a user may scroll to see the details for multiple participants. In this example, a namespace 902 identifies one partner A-1 Reseller. The details for partner 902 are listed as categories and measures 906 listed in the left most column. A period column 904 labeled Q1-05 contains the result data and performance level for categories and measures 906 for the first quarter of 2005. A period column 905 labeled Q2-05 contains the result data and performance level for the same categories and measures 906 for the next quarter of 2005.

In this example, a performance legend 903 is provided that may be color coded as well. “Excellent Performance”, the strongest level, may be coded blue, while the next strongest level, “Meets Expectations and Goals”, might be coded green followed by the weakest level “Performance Immature”, which might be coded red. Any scheme is acceptable here.

The color coding extends down into the details by period column and category and measure rows indicating the performance ranking for those results in the cell. Cells are illustrated as cells 9076 in this example. For example, the category Revenue for reseller A-1 is ranked the highest ranking possible for Q1-05 and for Q2-05. The measures under that category, which include “Targets”, “Target History”, “Target Approach”, and “Revenue Impact” may all be color coded blue to indicate the performance ranking for each of those. It is possible that one or more cells 907 in the measure rows under column 904 or 905 receive a second strongest ranking and therefore may be green instead of blue without affecting the overall score for the category depending on the granularity of the performance scale. The soft data description of the data results in the measures associated with the appropriate performance anchor would appear in each cell 907 in the appropriate row and in the appropriate column. It is important to note herein that the description may be a numerical value or a set of numerical values without departing from the spirit and scope of the present invention for certain hard data categories. For soft data categories, a narrative summary may be more appropriate.

In this example, the category “Sponsorship” for reseller A-I receives the strongest ranking of “Excellent Performance” for Q1-05. In the second quarter of 05 however, the weakest ranking “Performance Immature” is assigned to the category sponsorship. The measures for sponsorship in this example are commitment levels. “Commitment Internal” is the first listed measure under sponsorship, “Commitment to Partner” is another measure and “Competition” represents a third measure under the category.

In this example, all of the cells under Q1-05 for the category sponsor may be coded blue. For Q2-05 however on or more of the cells will be color coded in accordance with the actual level for that measure. For example, the cell for Internal Commitment in column 905 for that measure may meet all goals and expectations while the cell below that in the same column associated with partner commitment might by coded red for “Immature Performance”. The data display screen 900 may be repeated down the document vertically or across the document horizontally for as many partners as were included in the report.

In the report generation process, some soft data collected may be parsed and then analyzed by the system using a semantic library in order to equate the soft data to some existing performance anchor. In some cases where both soft and hard data may be crunched to obtain a ranking level, the ranking level chosen may reflect any dings that were there but were not sufficient to change the category level completely. For example, it may be that a partner receives the strongest ranking for the category revenue while one of the category measures received an immature ranking. This can be noted by color coding as described in this example, or some other way such as a footnote or other flag indicating some variance in levels for the measures of the category ranked.

In one embodiment, the same data results displayed in table form in this example may be presented in some graphics form in another example. A spider chart may be constructed according to the categories, measures and performance ranking. There are many possibilities.

One with skill in the art of data report management will appreciate that a snapshot record may be assigned an overall numerical value, or snapshot record value, that may be then used as data within other snapshot reports. This process is termed snapshot nesting by the inventor. A snapshot record value may be used as the performance rank for a measure in a superior snapshot record. Using the model described earlier for calculating a snapshot record value, when all of the categories of the record receive a 9, for example, the overall snapshot record value equals the square root of the sum of the category values divided by the number of categories. In this model if one or more of the categories receives a score lower than 9, then the snapshot record value equals 2.

Assume 5 categories with all categories receiving a score of 25, then the snapshot record value would equal 5. If all of the categories received a 9, then the snapshot record value would equal 3. If at least one category received a score of less than 9, then the snapshot record would equal 2. Through this approach, the snapshot record value for a snapshot record in a subsidiary snapshot record can be used as a measure value in a superior snapshot record. A purpose for this value transfer may be to allow performance tracking for one snapshot record in one application instance to provide information to another snapshot record in another application instance. This approach could allow, for instance, the performance linkage of “tactical” programs into “strategic” programs in an arbitrary hierarchy. In such an arrangement, weak performance in a subordinate snapshot record can manifest as a nested value and reflect weak performance in a superior snapshot record, thereby “flagging” the particular issue affected by the weak score. This approach can be employed with an arbitrary number of nesting levels with similar results.

It will be apparent to the skilled practitioner that the embodiments describe above are exemplary of inventions that may have greater scope than any of the singular descriptions. There may be many alterations made in these examples without departing from the spirit and scope of the invention. For example, templates may reflect alternate measurement models, calculated values may depend on other algorithms, nesting models may vary, and user interfaces and operating environments may vary. These and other features may change in different embodiments.

The methods and apparatus of the present invention, in light of the many embodiments described, should be afforded the broadest possible scope under examination. The spirit and scope of the present invention shall be limited only by the following claims.

What is claimed is:

1. A network-based data management service comprising:
a first network entry point for client-to-business interface and servicing;
a second network entry point for client-to-client interface and social interactivity;
a data repository for storing secure and public data;
an application server running at least one application for result calculation, performance ranking, and report generation; and
a template containing data about reporting subjects, rules for reporting, and performance level guidelines.

2. The service of claim 1, wherein the network is a data-packet-network.

3. The service of claim 2, wherein the data-packet-network is the Internet network.

4. The service of claim 1, wherein the first network entry point is a secure Web server connected to the application server.

5. The service of claim 1, wherein the first network entry point is an interactive voice response unit connected to the application server.

6. The service of claim 1, wherein the second network entry point is a Web server.

7. The service of claim 1, wherein the public data includes templates created by clients, the templates of the form of a table containing suggestive rules for reporting, performance level guidelines, and suggested entity types.

8. The service of claim 1, wherein the application executes upon client directive and aggregates data for one or more periods for one or more entity and performs calculations and performance-scoring according to constraints in the template identified.

9. The service of claim 1, wherein the application generates one or more reports of a tabular or of a graphical form automatically repeating execution for each subsequent same period of activity.

10. The service of claim 9, wherein the tabular and graphical reports are exportable to a spreadsheet document, a slide presentation document, or a text or email document.

11. The service of claim 1, further including one or more network server adaptors for connecting to third party data resources on the network and acquiring data from those resources for use in analysis.

12. The service of claim 1, wherein client-to client interface and social interactivity is accomplished through one or a combination of chat, instant messaging, white boarding, electronic posting board, forums, and file sharing any of which may be configured or not to a client interface by the client.

13. In a network-based data management service, a scoring module including:
a class object defined as category;
a class object defined as category measure;
a class object defined as measure performance anchor; and
two or more performance level objects of descending or ascending hierarchy none equal in value to the other.

14. The module of claim 13, associated with a template and wherein the objects are defined with attributes specified by the client.

15. The system of claim 1, further including a scoring module accessible to the application, the application using the measure performance values, as defined through a performance anchor model, during the calculation process as variables for performance ranking.

16. In a network-based data management service, a method for evaluating one or more associate entities of a service client including the acts:
(a) identifying and selecting the one or more associate entities for evaluation;
(b) identifying and selecting one or more measurable categories for the one or more associate entities selected;
(c) identifying and selecting one or more category measures for the selected categories;
(d) identifying and selecting two or more performance anchors that may be associated to the one or more selected category measures; and
(e) initiating the evaluation process.

17. The method of claim 16, wherein in act (a) the associate entities are one of resellers, manufacturers, or retail locations of business.

18. The method of claim 16, wherein in act (b), the measurable categories include those supported by hard numerical data and/or soft data like text description and supporting documents.

19. The method of claim 16, wherein in act (c), the category measures are attributes of the categories.

20. The method of claim 16, wherein in act (d), at least one of the performance anchors is assigned a value consistent with the snapshot record value of an existing snapshot record.

21. The method of claim 19, wherein in act (d), the calculation of category values and snapshot record values is based on available data and a performance level definition.

22. The method of claim 20, wherein in act (d), an existing snapshot record value is nested into a separate snapshot record.
